(19) United States
(12) Patent Application Publication
(10) Pub. No.: US 2005/0285826 A1
(43) Pub. Date: Dec. 29, 2005

(54) Light emitting display

(76) Inventors: Sung-Cheon Park, Suwon (KR); Jin-Tae Jeong, Seoul (KR)

Correspondence Address: Robert E. Bushnell, Suite 300, 1522 K Street, Washington, DC, 20005-1202, US

(21) Appl. No.: 11/139,672

(22) Filed: May 31, 2005

(30) Foreign Application Priority Data
Jun. 24, 2004 (KR) 2004-47889

(51) Int. Cl. G09G 3/30

(52) U.S. Cl. 345/76

(57) ABSTRACT

A light emitting display has a main displaying part and a subsidiary displaying part formed on one substrate and equalized in brightness. The light emitting display comprises: a first displaying part formed on a substrate and displaying a picture; a second displaying part formed on the substrate and displaying a picture; a first driving power line for supplying first driving power to the first displaying part; and a second driving power line for supplying second driving power, different from the first driving power, to the second displaying part. With this configuration, the invention provides a light emitting display in which the main displaying part and the subsidiary displaying part are equalized in brightness.

### CLAIM OF PRIORITY

This application makes reference to, incorporates the same herein, and claims all benefits accruing under 35 U.S.C. § 119 from an application for LIGHT EMITTING DISPLAY earlier filed in the Korean Intellectual Property Office on Jun. 24, 2004 and there duly assigned Serial No. 2004-0047889.

### BACKGROUND OF THE INVENTION

1. Technical Field

The present invention relates to a light emitting display and, more particularly, to a light emitting display in which a main displaying part and a subsidiary displaying part formed on one substrate are equalized in brightness.

2. Related Art

Recently, various flat panel displays have been developed, and these flat panel displays substitute for a cathode ray tube (CRT) display because the CRT display is relatively heavy and bulky. The flat panel displays include a liquid crystal display (LCD), a field emission display (FED), a plasma display panel (PDP), a light emitting display (LED), and the like.

Among flat panel displays, the light emitting display can emit light for itself by electron-hole recombination allowing a fluorescent layer thereof to emit the light. Light emitting displays are classified into an inorganic light emitting display comprising an inorganic emitting layer, and an organic light emitting display comprising an organic emitting layer. Such a light emitting display has the advantage of fast response time as in the CRT display, as compared with a passive light emitting device such as an LCD which requires a separate light source.

Generally, the light emitting display comprises an emitting layer, an electron transport layer, and a hole transport layer, which are interposed between an anode electrode and a cathode electrode. Additionally, the light emitting display can include an electron injection layer and a hole injection layer.

In the light emitting display, when voltage is applied between the anode electrode and the cathode electrode, electrons generated by the cathode electrode move to the emitting layer via the electron injection layer and the electron transport layer, and holes generated by the anode electrode move to the emitting layer via the hole injection layer and the hole transport layer. Then, the electrons from the electron transport layer and the holes from the hole transport layer are recombined in the emitting layer, thereby emitting light.

The light emitting display has recently been used as a double sided display in mobile phones, portable terminals, and the like, wherein the double sided display allows a display part to display information regardless of an opened state or a closed state of the display part.

Such a double sided display comprises a main displaying part and a subsidiary displaying part, so that a display device for the subsidiary displaying part is additionally needed. Generally, the main displaying part and the subsidiary displaying part overlap each other so that a problem arises in that the double sided display becomes thick.

### SUMMARY OF THE INVENTION

Accordingly, it is an object of the present invention to provide a double sided display in which a main displaying part and a subsidiary displaying part are formed on one substrate.

The forgoing and/or other aspects of the present invention are achieved by providing a light emitting display comprising: a first displaying part formed on a substrate for displaying a picture; a second displaying part formed on the substrate for displaying a picture; a first driving power line for supplying first driving power to the first displaying part; and a second driving power line for supplying second driving power, different from the first driving power, to the second displaying part.

According to an aspect of the invention, the first driving power line is formed along edges of the substrate except for one edge, and the second driving power line is formed along one edge of the substrate adjacent to the second displaying part. Furthermore, the light emitting display comprises: a scan driver for transmitting a scan signal to the first and second displaying parts; a data driver for transmitting a data signal to the first and second displaying parts; and a controller for controlling the scan and data drivers, and for generating first driving power and second driving power. Preferably, the second driving power is higher than the first driving power by 1 volt or more.

Another aspect of the present invention is achieved by providing a light emitting display comprising: a first displaying part for displaying a picture based on a scan signal transmitted to i scan lines (where i is a positive integer), a data signal transmitted to a plurality of data lines, and first driving power; and a second displaying part for displaying a picture based on a scan signal transmitted to j scan lines (where j is a positive integer), the data signal transmitted to the plurality of data lines, and second driving power, wherein the first driving power and the second driving power are different from each other in voltage level.

According to an aspect of the invention, the light emitting display further comprises: a scan driver for transmitting the scan signal to the i scan lines, and for transmitting the scan signal to the j scan lines; and a data driver for transmitting the data signal to the plurality of data lines. Furthermore, the first displaying part comprises a first pixel circuit defined by the i scan lines and the plurality of data lines for causing the first driving power to have current corresponding to the data signal in response to the scan signal; and a plurality of pixels, including a light emitting device, for emitting light with the current outputted from the first pixel circuit. Preferably, the second displaying part comprises a second pixel circuit defined by the j scan lines and the plurality of data lines for causing the second driving power to have current corresponding to the data signal in response to the scan signal; and a plurality of pixels, including a light emitting device, for emitting light with the current outputted from the second pixel circuit.

Still another aspect of the present invention is achieved by providing a light emitting display comprising: a first displaying part formed on a substrate and having a plurality of first pixels defined by i first scan lines (where i is a positive integer) and a plurality of data lines, and a first pixel power line for supplying first driving power to the plurality of first pixels; and a second displaying part formed on the substrate and having a plurality of second pixels defined by j second scan lines (where j is a positive integer) and the plurality of data lines, and a second pixel power line for supplying second driving power, different from the first driving power, to the plurality of second pixels. Preferably, the first pixel comprises: a first pixel circuit electrically connected to the first scan line, the data line, and the light emission control line for causing the first driving power to have current corresponding to the data signal in response to the first scan signal transmitted to the first scan line; and a light emitting device emitting light with the current outputted from the first pixel circuit. Furthermore, the second pixel comprises: a second pixel circuit electrically connected to the second scan line and the data line for causing the second driving power to have current corresponding to the data signal in response to the second scan signal transmitted to the second scan line; and a light emitting device for emitting light with the current outputted from the second pixel circuit.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view illustrating a light emitting display according to a first embodiment of the present invention;

FIG. 2 is a circuit diagram illustrating pixels of main and subsidiary displaying parts according to an embodiment of the present invention;

FIG. 3 is a view illustrating waveforms of driving signals for driving the pixel of the main displaying part according to an embodiment of the present invention;

FIG. 4 is a view illustrating waveforms of driving signals for driving the pixel of the subsidiary displaying part according to an embodiment of the present invention;

FIG. 5 is a schematic side view illustrating displaying directions of the main and subsidiary displaying parts according to an embodiment of the present invention;

FIG. 6 is a graph showing current flow in the subsidiary displaying part with respect to second driving power according to an embodiment of the present invention; and

FIG. 7 is a view illustrating a light emitting display according to a second embodiment of the present invention.

### DETAILED DESCRIPTION OF THE INVENTION

Hereinafter, preferable embodiments according to the present invention will be described with reference to the accompanying drawings, wherein the preferred embodiments of the present invention are provided in such a way as to be readily understood by those skilled in the art.

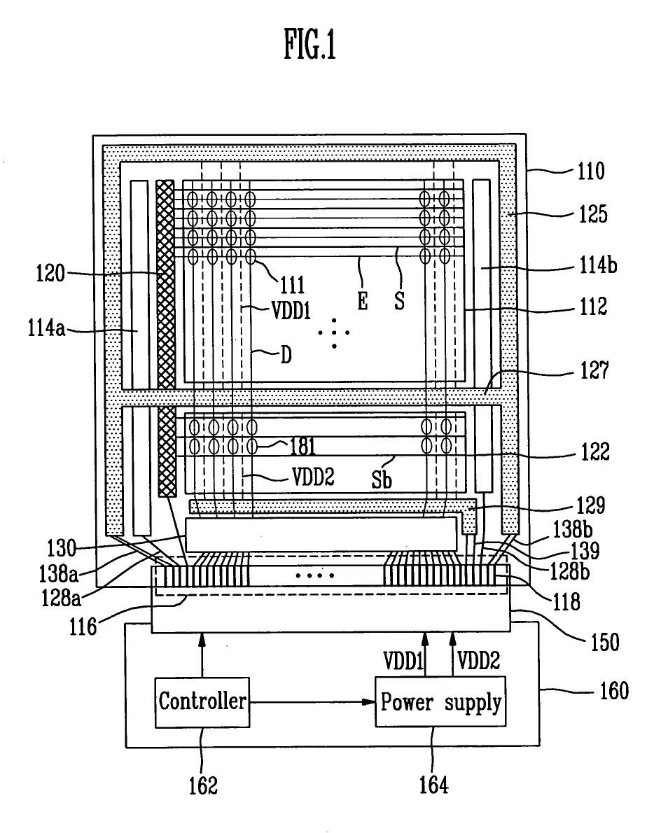

FIG. 1 is a view illustrating a light emitting display according to a first embodiment of the present invention.

Referring to FIG. 1, a light emitting display according to the first embodiment of the present invention comprises a substrate 110, a control unit 160, and a flexible printed circuit (FPC) 150.

The substrate 110 comprises a main displaying part 112, a subsidiary displaying part 122, a scan driver 120, a data driver 130, a pad part 116, a first driving power line 125, a second driving power line 129, and base power lines 114a and 114b.

The main displaying part 112 comprises a plurality of pixels 111 which are defined by i scanning lines S (where i is a positive integer), a plurality of data lines D, and a light emission control line En. Each pixel 111 of the main displaying part 112 is selected when a scan signal is applied to the scan line S, and emits light corresponding to a data signal applied to the data line D.

The subsidiary displaying part 122 comprises a plurality of pixels 181 which are defined by j scanning lines Sb (where j is a positive integer) and a plurality of data lines D. Each pixel 181 of the subsidiary displaying part 122 is selected when a scan signal is applied to the scan line Sb, and emits light corresponding to the data signal applied to the data line D.

The control unit 160 comprises a controller 162 and a power supply 164. The control unit 160 is provided in the FPC 150, and is electrically connected to the pad part 116 of the substrate 110 through the FPC 150.

The controller 162 generates a scan control signal for controlling the scan driver 120, and a data control signal for controlling the data driver 130. Furthermore, the controller 162 rearranges external video data so that it is adapted for the main displaying part 112 and the subsidiary displaying part 122, and controller 162 transmits the data to the data driver 130. Also, the controller 162 drives the power supply 164 so as to cause it to operate.

The power supply 164 generates first driving power and second driving power having voltage levels different from each other, and transmits the first and second driving powers to the first and second driving power lines 125 and 129, respectively. Furthermore, the power supply 164 generates base power, and transmits it to the base power lines 114a and 114b. In this regard, the second driving power has a voltage level higher than that of the first driving power by 1 volt or more. Furthermore, the base power has a base voltage lower than those of the first driving power and second driving power, or has a ground level voltage.

The pad part 116 comprises a plurality of pads 118 formed along one edge of the substrate 110. Furthermore, the pad part 116 is electrically connected to the FPC 150 by an anisotropic conductive film. Each pad 118 of the pad part 116 is electrically connected to the first and second driving power lines 125 and 129 and the base power lines 114a and 114b through a signal line.

The first driving power line 125 is disposed along the edges of the substrate 110 excluding the edge formed with the pad part 116. Furthermore, the first driving power line 125 comprises an auxiliary power line 127 placed between the main displaying part 112 and the subsidiary displaying part 122, and branched from the first driving power line 125. The first driving power line 125 has opposite terminals connected to the pad 118 for receiving the first driving power from the FPC 150 among the plurality of pads 118 through power lines 138a and 138b. Thus, the first driving power is supplied by the FPC 150 to the main displaying part 112 through both the first driving power line 125 and the auxiliary power line 127.

The second driving power line 129 is placed between the subsidiary displaying part 122 and the data driver 130, and has one terminal connected to the pad 118 for receiving the second driving power from the FPC 150 among the plurality of pads 118 through a power line 139. Thus, the second driving power is supplied by the FPC 150 to the subsidiary displaying part 122 through the second driving power line 129.

According to an embodiment of the present invention, the first and second driving power lines 125 and 129, respectively, are individually formed on the substrate 110.

The base power lines 114a and 114b are disposed in parallel with opposite sides of both the main displaying part 112 and the subsidiary displaying part 122, and are connected to the pad 118 receiving the base driving power from the FPC 150 among the plurality of pads 118 through power lines 128a and 128b. Thus, base power is supplied by the FPC 150 to both the main displaying part 112 and the subsidiary displaying part 122 through the base power lines 114a and 114b.

The data driver 130 is mounted between the pad 116 and the subsidiary displaying part 122, and is electrically connected to the plurality of pads 118 through a first signal line and to the data line D through a second signal line. As a method for mounting the data driver 130, there are a chip-on-glass method, a wire-bonding method, a flip chip method, a beam lead method, etc.

The data driver 130 converts video data into a data signal in response to the data control signal supplied by the FPC 150 through the first signal line, and then transmits the data signal to the data line D of both the main displaying part 112 and the subsidiary displaying part 122. The data line D is common to the main displaying part 112 and the subsidiary displaying part 122. That is, the data signal supplied to one data line D is transmitted to both the main displaying part 112 and the subsidiary displaying part 122.

The scan driver 120 is connected to at least one of the plurality of pads 118 through third signal lines. The scan driver 120 transmits the scan signal to the main displaying part 112 and the auxiliary display 122 in sequence in response to the scan control signal supplied by the FPC 150 through at least one pad 118 and the third signal line, that is, in response to a start pulse and a clock signal.

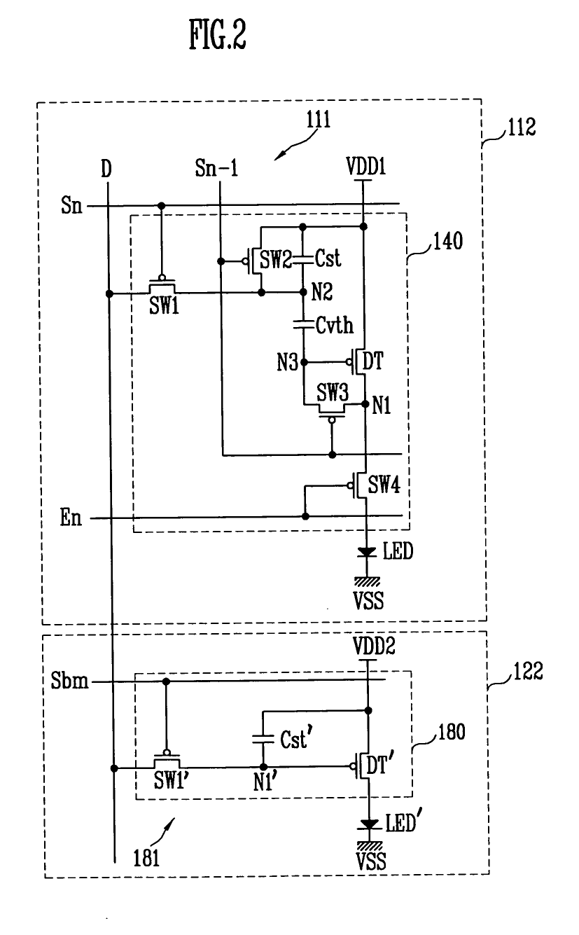

FIG. 2 is a circuit diagram illustrating pixels of main and subsidiary displaying parts according to an embodiment of the present invention.

As shown in FIG. 2 associated with FIG. 1, each pixel 111 of the main displaying part 112 comprises a first pixel circuit 140 for converting the first driving power supplied by the first driving power line VDD1 so that it has a current corresponding to the data signal supplied to the data line D in response to the scan signal transmitted to the scan line S, and a light emitting device LED for emitting light on the basis of the current outputted by the first pixel circuit 140. The first pixel circuit 140 is electrically connected to the data line D, the scan line S, the light emission control line En, and a first pixel power line VDD1.

The light emitting device LED has an anode electrode connected to the first pixel circuit 140, and a cathode electrode connected to a common power line VSS for supplying the base power. For reference, the light emitting device LED includes an organic light emitting diode (OLED).

The OLED comprises an organic light emitting layer, an electron transport layer, and a hole transport layer, which are interposed between the anode electrode and the cathode electrode. Additionally, the OLED comprises an electron injection layer and a hole injection layer. In the OLED, when power is applied between the anode electrode and the cathode electrode, electrons generated by the cathode electrode move to the emitting layer via the electron injection layer and the electron transport layer, and holes generated by the anode electrode move to the emitting layer via the hole injection layer and the hole transport layer. Then, the electrons from the electron transport layer and the holes from the hole transport layer are recombined in the emitting layer, thereby emitting light.

The first pixel circuit 140 comprises: a driving thin film transistor (TFT) DT connected between the first pixel power line VDD1 and the light emitting device LED; a first switching device SW1 connected to an N^{th} scan line (where N is a positive integer) Sn; a second switching device SW2 connected to the first switching device SW1, the first pixel power line VDD1, and an (N-1)th scan line Sn-1; a fourth switching device SW4 connected to the light emission control line En, the light emitting device LED and the driving TFT DT; a third switching device SW3 connected to a first node N1 between the driving TFT DT and the fourth switching device SW4, to the (N-1)^{th} scan line Sn-1, and to a gate electrode (i.e., a third node N3) of the driving TFT DT; a storage capacitor Cst connected between the first pixel power line VDD1 and a second node N2 connected to both the first switching device SW1 and the second switching device SW2; and a compensation capacitor Cvth connected between the second node N2 and the third node N3. The TFT DT is, preferably, a P-type metal oxide semiconductor field effect transistor.

The first switching device SW1 comprises a gate electrode connected to the Nth scan line Sn, a source electrode connected to the data line D, and a drain electrode connected to the second node N2. The first switching device SW1 transmits the data signal from the data line D to the second node N2 in response to a first scan signal applied to the Nth scan line Sn.

The second switching device SW2 comprises a gate electrode connected to the (N-1)^{th} scan line Sn-1, a source electrode connected to the first pixel power line VDD1, and a drain electrode connected to a second node N2. The second switching device SW2 transmits voltage from the first pixel power line VDD1 to the second node N2 in response to the scan signal applied to the (N-1)^{th} scan line Sn-1.

The third switching device SW3 comprises a gate electrode connected to the (N-1)^{th} scan line Sn-1, a source electrode connected to the third node N3, and a drain electrode connected to the first node N1 connected between the driving TFT DT and a fourth switching device SW4. The third switching device SW3 connects the gate electrode of the driving TFT DT with the first node N1 in response to a second scan signal applied to the (N-1)^{th} scan line Sn-1.

The storage capacitor Cst stores voltage corresponding to the data signal applied to the second node N2 via the first switching device SW1 while the first scan signal is applied to the N^{th} scan line Sn, and keeps the driving TFT DT in a turned on state for one frame when the first switching device SW1 is turned off.

The compensation capacitor Cvth stores voltage corresponding to a threshold voltage of the driving TFT DT on the basis of voltage applied to the first pixel power line VDD1 while the second scan signal is applied to the (N-1)^{th} scan line Sn-1. That is, the compensation capacitor Cvth stores a compensation voltage for compensating the threshold voltage of the driving TFT DT while the second and third switching devices SW2 and SW3, respectively, are turned on.

The driving TFT DT comprises a gate electrode connected to both the source electrode of the third switching device SW3 and the compensation capacitor Cvth, a source electrode connected to the first pixel power line VDD1, and a drain electrode connected to a source electrode of the fourth switching device SW4. The driving TFT DT adjusts current flowing from the first pixel power line VDD1 to a fourth switching device SW4 according to the voltage applied between the gate and source electrodes of the driving TFT DT.

The fourth switching device SW4 comprises a gate electrode connected to the light emission control line En, a source electrode connected to the first node N1, and a drain electrode connected to the anode electrode of the light emitting device LED. The fourth switching device SW4 allows the current to flow from the driving TFT DT to the light emitting device LED in response to a light emission control signal ES on the light emission control line En, thereby causing the light emitting device LED to emit light.

Furthermore, the fourth switching device SW4 cuts off current passing between the driving TFT DT and the light emitting device LED while the data signal is programmed by the light emission control signal ES on the light emission control line En.

Each pixel 181 of the subsidiary displaying part 122 comprises a second pixel circuit 180 for converting the second driving power supplied by the second pixel power line VDD2 so that it has a current corresponding to the data signal supplied to the data line D in response to the scan signal transmitted on the scan line Sbm, and a light emitting device LED′ for emitting light on the basis of the current outputted by the second pixel circuit 180. The second pixel circuit 180 is electrically connected to the data line D, the scan line Sbm, and the second pixel power line VDD2.

The light emitting device LED′ has an anode electrode connected to the second pixel circuit 180, and a cathode electrode connected to a common power line VSS supplying the base power. For reference, the light emitting device LED′ includes an organic light emitting diode (OLED) as described above.

The second pixel circuit 180 comprises: a driving TFT DT′ connected between the second pixel power line VDD2 and the light emitting device LED′; a first switching device SW1′ connected to the scan line Sbm and the data line D; a storage capacitor Cst′ connected between the second pixel power line VDD2 and a first node N1′ connected to both the first switching device SW1′ and the driving TFT DT′. The driving TFT DT′ and the first switching device SW1′ are composed of a P-type metal oxide semiconductor field effect transistor (MOSFET).

The first switching device SW1′ comprises a gate electrode connected to the scan line Sbm, a source electrode connected to the data line D, and a drain electrode connected to the first node N1′. The first switching device SW1′ transmits the data signal from the data line D to the first node N1′ in response to a scan signal applied to the scan line Sbm.

The storage capacitor Cst′ stores voltage corresponding to the data signal applied to the first node N1′ via the first switching device SW1′ while the scan signal is applied to the scan line Sbm, and keeps the driving TFT DT′ turned on for one frame when the first switching device SW1′ is turned off.

The driving TFT DT′ comprises a gate electrode connected to the first node N1′ to which the drain electrode of the first switching device SW1′ and the storage capacitor Cst′ are commonly connected, a source electrode connected to the second pixel power line VDD2, and the drain electrode connected to the anode electrode of the light emitting device LED′. The driving TFT DT′ adjusts current flow from the second pixel power line VDD2 to the light emitting device LED′ according to the voltage applied between the gate and source electrodes of the driving TFT DT′, thereby causing the light emitting device to emit light.

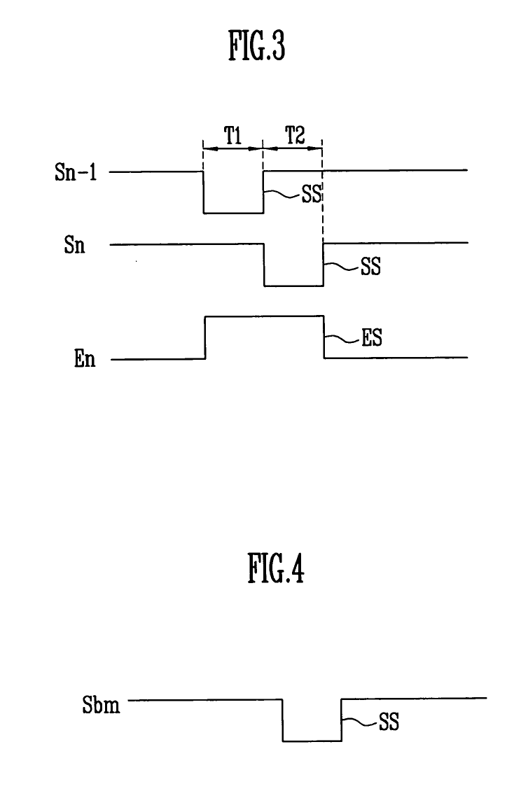

FIG. 3 is a view illustrating waveforms of driving signals for driving the pixel of the main displaying part according to an embodiment of the present invention.

Referring to FIG. 3 associated with FIG. 2, the pixels 111 formed in the main displaying part 112 operate as follows. First, for a period of T1 while a low second scan signal SS is applied to the (N-1)^{th} scan line Sn-1 and a high first scan signal SS is applied to the N^{th} scan line Sn, the second and third switching devices SW2 and SW3 are turned on and the first switching device SW1 is turned off. Further, the fourth switching device SW4 is turned off in response to a high light emission control signal ES applied to the light emission control line En, thereby cutting off the current passing between the driving TFT DT and the light emitting device LED.

Thus, the driving TFT DT functions as a diode, and the voltage between the gate and source electrodes of the driving TFT DT varies until it is equal to the threshold voltage Vth of the driving TFT DT. Hence, the compensation capacitor Cvth stores a compensation voltage corresponding to the threshold voltage Vth of the driving TFT DT.

Subsequently, for a second period of T2 while a high second scan signal SS is applied to the (N-1)^{th} scan line Sn-1 and a low first scan signal SS is applied to the Nth scan line Sn, the second and third switching devices SW2 and SW3 are turned off and the first switching device SW1 is turned on. At this time, the data signal is transmitted from the data line D to the first node N1 through the first switching device SW1, the compensation capacitor Cvth, and the driving TFT DT. Therefore, the sum of the voltage difference Vdata−VDD at the second node N2 and the compensation voltage stored in the compensation capacitor Cvth is supplied to the gate electrode of the driving TFT DT.

Hence, a voltage Vgs applied between the gate and source electrodes of the driving TFT DT for the period T2 is calculated by the following equation 1.
Vgs=Vth+Vdata−VDD1 [Equation 1]
where ‘Vth’ is the threshold voltage of the driving TFT DT, ‘Vdata’ is a data signal, and ‘VDD1’ is the first driving voltage.

Furthermore, the storage capacitor Cst stores the voltage difference at the second node N2. In addition, for the period T2, the fourth switching device SW4 is turned on by the high light emission control signal ES of the light emission control line En. At this point, the driving TFT DT is turned on by the sum of the voltage difference at the second node N2 and the compensation voltage stored in the compensation capacitor Cvth, and transmits a current corresponding to the compensated data signal to the fourth switching device SW4. Thus, the light emitting device LED emits light as a result of the current applied by the driving TFT DT via the fourth switching device SW4, thereby displaying a picture.

After the period of T2, that is, while the high first scan signal SS is applied to the the Nth scan line Sn, the driving TFT DT is kept in a turned on state by the data signal stored in the storage capacitor Cst so that the light emitting device LED emits light for one frame, thereby displaying a picture.

The main displaying part 112 employs the compensation capacitor Cvth and the second and third switching devices SW2 and SW3, respectively, for compensating the threshold voltage Vth of the driving TFT DT provided in each pixel 111 even though the pixels 111 are different from each other with respect to the threshold voltage Vth of the driving TFT DT, thereby rendering the brightness of the pixels 111 uniform regardless of their positions. The main displaying part 112 can control the current applied to the light emitting device LED, as well as compensate the threshold voltage Vth of the driving TFT DT, so that it can display a moving picture and a still picture and, in particular, mainly display the moving picture.

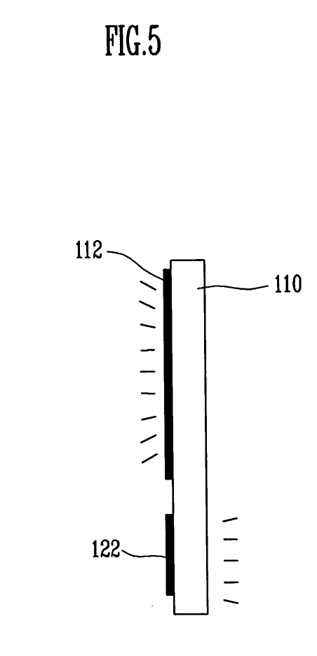

FIG. 4 is a view illustrating waveforms of driving signals for driving the pixel of the subsidiary displaying part according to an embodiment of the present invention.

Referring to FIG. 4 associated with FIG. 2, the pixels 181 of the subsidiary displaying part 122 operate as follows. First, while a low scan signal SS is transmitted to the scan line Sbm, the first switching device SW1′ is turned on. Thus, the data signal is transmitted from the data line D to the gate electrode of the driving TFT DT′ through the first switching device SW1′ and the first node N1′. At this point, the storage capacitor Cst′ stores the voltage applied between the gate and source electrodes of the driving TFT DT′.

Thus, the driving TFT DT′ is turned on by the voltage applied to the first node N1′, thereby applying a current corresponding to the data signal to the light emitting device LED′. Therefore, the light emitting device LED′ emits light as a result of the current applied by the driving TFT DT′ in order to display a picture.

Subsequently, while a high scan signal SS is transmitted to the scan line Sbm, the driving TFT DT′ is kept in a turned on state by a voltage corresponding to the data signal stored in the storage capacitor Cst′, so that the light emitting device LED′ emits light and displays a picture for one frame. The subsidiary displaying part 122 mainly displays a still picture, including text.

FIG. 5 is a schematic side view illustrating displaying directions of the main and subsidiary displaying parts according to an embodiment of the present invention.

Referring to FIG. 5, in the light emitting display according to an embodiment of the present invention, the main displaying part 112 displays a picture in a frontward direction of the substrate 110, and the subsidiary displaying part 122 displays a picture in a rearward direction of the substrate 110. Thus, the light emitting display according to an embodiment of the present invention can display a picture in both the frontward and rearward directions of the substrate 110. That is, the light emitting display according to an embodiment of the present invention displays a picture in dual directions of the substrate 110.

Furthermore, in the light emitting device according to an embodiment of the present invention, first driving power is supplied to the pixels 111 of the main displaying part 112 and second driving power, different from the first driving power, is supplied to the pixels 181 of the subsidiary displaying part 122 so that the main displaying part 112 and the subsidiary displaying part 122 are equalized in brightness.

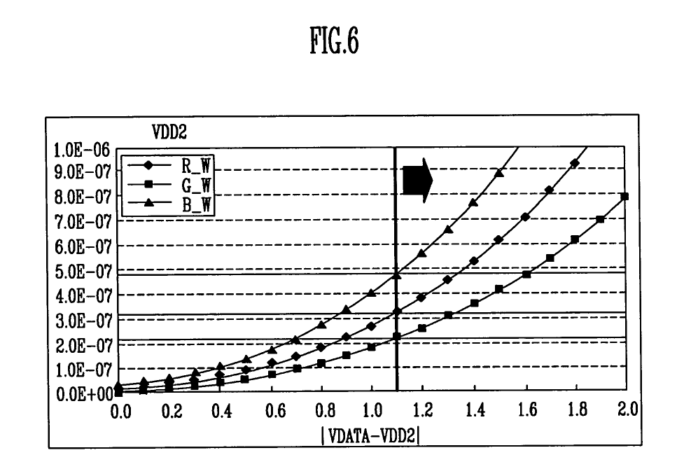

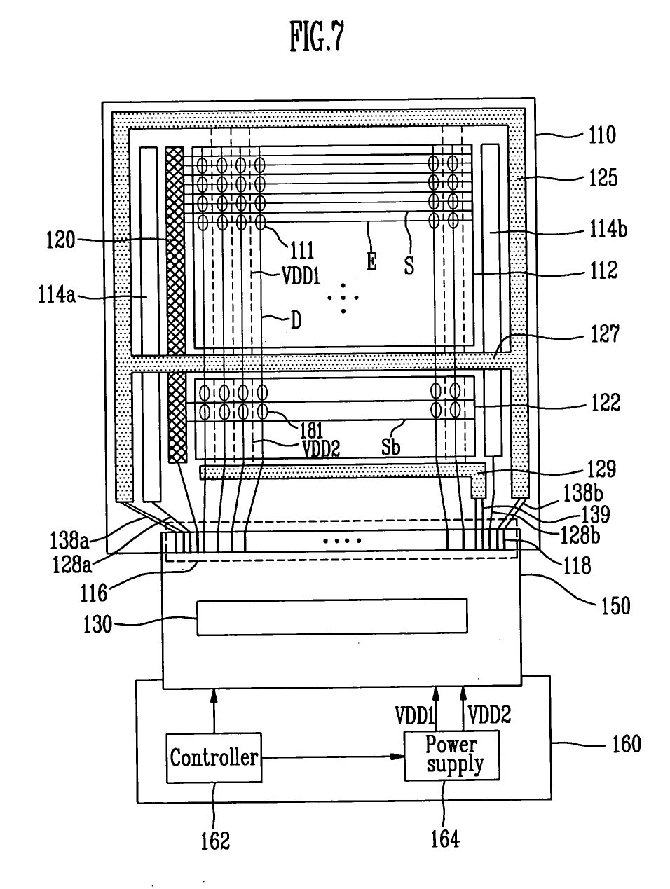

FIG. 6 is a graph showing current flow in the subsidiary displaying part with respect to second driving power according to an embodiment of the present invention.

Referring to FIG. 6 associated with FIG. 2, when the first driving power VDD1 of 5V is supplied to each pixel 111 of the main displaying part 112 and the data signal Vdata has a black level of 5V, |Vdata−VDD1| has a value of 0V. At this point, in order to equalize the brightness of the auxiliary display 122 with that of the main displaying part 112, the second driving power VDD2 should satisfy the requirement, |Vdata−VDD2| is equal to or greater than one volt. In other words, the brightness of the light emitting device LED varies according to the amount of the current applied thereto, so that the second driving power should be higher than the first driving power by one volt or more in order to reduce the current difference between the main displaying part 112 and the subsidiary displaying part 122.

Thus, in the light emitting display according to an embodiment of the present invention, the second driving power supplied to the pixel 181 of the subsidiary displaying part 122 is higher than the first driving power supplied to the pixel 111 of the main displaying part 112 by 1V or more, thereby equalizing the brightness of the main displaying part 112 with that of the subsidiary displaying part 122.

FIG. 7 is a view illustrating a light emitting display according to a second embodiment of the present invention. As shown therein, the light emitting display according to this embodiment has the same configurations as the foregoing light emitting display of the first embodiment except for the provision of a data driver 130 for transmitting a data signal to a data line D of the main displaying part 112 and the subsidiary displaying part 122.

The data driver 130 of the light emitting display according to the second embodiment of the present invention can be mounted on the FPC 160 connected to the substrate 110. Thus, the data driver 130 is electrically connected to the data line D of the main displaying part 112 and the subsidiary displaying part 122 through the pad part of the substrate 110, thereby transmitting the data signal. Alternatively, the data driver 130 may be mounted by means of a chip-on-board method in which the data driver 130 is mounted on a printed circuit board, by means of a chip-on-film method in which the data driver 130 is directly mounted on a film, or by means of a general film type connecting device employed in a table carrier package.

The foregoing light emitting display according to the second embodiment of the present invention can be employed in a mobile phone or in a mobile communication terminal. In the case of a mobile phone, the main displaying part 112 is used as an inner display of the mobile phone, and the subsidiary displaying part 122 is used as an outer display of the mobile phone.

Furthermore, in the light emitting display according to the second embodiment of the present invention, the pixel circuit 140 of the main displaying part 112 comprises five switching devices and two capacitors but is not limited thereto, and may comprise two switching devices and a single capacitor as in the pixel circuit 180 of the subsidiary displaying part 122.

As described above, the present invention provides a light emitting display in which a main displaying part and a subsidiary displaying part are equalized in brightness.

Furthermore, the present invention provides a light emitting display in which a main displaying part and a subsidiary displaying part are equalized in brightness without changing the circuitry of the subsidiary displaying part.

In addition, the present invention provides a light emitting display in which pixel power lines of a main displaying part and a subsidiary displaying part are individually disposed, thereby solving the problem of voltage drop in the pixel power line.

Although preferred embodiments of the present invention have been shown and described, it should be appreciated by those skilled in the art that changes can be made in these embodiments without departing from the principles and spirit of the invention, the scope of which is defined in the claims and their equivalents.

1. A light emitting display comprising:
a first displaying part formed on a substrate for displaying a picture;
a second displaying part formed on the substrate for displaying a picture;
a first driving power line for supplying first driving power to the first displaying part; and
a second driving power line for supplying second driving power, different from the first driving power, to the second displaying part.

2. The light emitting display according to claim 1, wherein the first driving power line is formed along edges of the substrate except for one edge of the substrate.

3. The light emitting display according to claim 2, wherein the second displaying part comprises:
a second pixel circuit defined by a plurality of scan lines by which a scan signal is transmitted and a plurality of data lines by which a data signal is transmitted, said second displaying part causing the second driving power to have a current corresponding to the data signal in response to the scan signal; and
a light emitting device for emitting light in response to a current outputted by the second pixel circuit.

4. The light emitting display according to claim 3, wherein the second pixel circuit comprises:
a driving transistor having a gate electrode connected to a first node, a source electrode connected to the second driving power line, and a drain electrode connected to the light emitting device;
a switching device controlled by a scan signal transmitted by a scan line, and connected to the data line and the first node; and
a storage capacitor having a first terminal connected to the second driving power line and a second terminal connected to the first node.

5. The light emitting display according to claim 1, wherein the second driving power line is formed along one edge of the substrate adjacent to the second displaying part.

6. The light emitting display according to claim 1, further comprising:
a scan driver for transmitting a scan signal to the first and second displaying parts;
a data driver for transmitting a data signal to the first and second displaying parts; and
a controller for controlling the scan driver and the data driver, and for generating first driving power and the second driving power.

7. The light emitting display according to claim 6, further comprising a film type connector having the controller provided thereon for electrically connecting the controller to the substrate.

8. The light emitting display according to claim 7, wherein the data driver is provided on the film type connector.

9. The light emitting display according to claim 6, wherein the first displaying part comprises a first pixel circuit defined by a plurality of scan lines to which the scan signal is transmitted and a plurality of data lines to which the data signal is transmitted, the first display part causing the first driving power to have a current corresponding to the data signal in response to the scan signal, said first displaying part further comprising a light emitting device for emitting light in response to current outputted by the first pixel circuit.

10. The light emitting display according to claim 9, further comprising a plurality of light emission control lines formed on the substrate for transmitting a light emission control signal to the first displaying part.

11. The light emitting display according to claim 10, wherein the first pixel circuit comprises:
a driving transistor having a drain electrode connected to a first node, a gate electrode connected to a third node, and a source electrode connected to the first driving power line;
a compensation capacitor having a first terminal connected to a second node, and a second terminal connected to the third node;
a first switching device controlled by a first scan signal transmitted to a first scan line, and connected to a data line and the second node;
a second switching device controlled by a second scan signal transmitted to a second scan line, and connected to the second node and the first driving power line;
a third switching device controlled by the second scan signal, and connected to the first node and the third node;
a fourth switching device controlled by the light emission control signal transmitted by a light emission control line, and connected to the first node and the light emitting device; and
a storage capacitor having a first terminal connected to the first driving power line and a second terminal connected to the second node.

12. The light emitting display according to claim 1, wherein the second driving power is greater than the first driving power by at least one volt.

13. A light emitting display, comprising:
a first displaying part for displaying a picture based on a scan signal transmitted via i scan lines where i is a positive integer, a data signal transmitted via a plurality of data lines, and a first driving power; and
a second displaying part for displaying a picture based on a scan signal transmitted via j scan lines where j is a positive integer, the data signal transmitted via the plurality of data lines, and a second driving power;
wherein the first driving power and the second driving power are different from each other in voltage level.

14. The light emitting display according to claim 13, further comprising:
a scan driver for transmitting the scan signal via the i scan lines, and for transmitting the scan signal via the j scan lines; and
a data driver for transmitting the data signal via the plurality of data lines.

15. The light emitting display according to claim 14, wherein the first displaying part comprises:
a first pixel circuit defined by the i scan lines and the plurality of data lines for causing the first driving power to have a current corresponding to the data signal in response to the scan signal; and
a plurality of pixels including a light emitting device for emitting light in response to a current outputted by the first pixel circuit.

16. The light emitting display according to claim 15, further comprising a plurality of light emission control lines for transmitting a light emission control signal to the first displaying part.

17. The light emitting display according to claim 16, wherein the first pixel circuit comprises:
a driving transistor having a drain electrode connected to a first node, a gate electrode connected to a third node, and a source electrode connected to the first driving power line;
a compensation capacitor having a first terminal connected to the second node, and a second terminal connected to the third node;
a first switching device controlled by a first scan signal transmitted via a first scan line, and connected to the data line and to the second node;
a second switching device controlled by a second scan signal transmitted via a second scan line, and connected to the second node and to the first driving power line;
a third switching device controlled by the second scan signal, and connected to the first node and to the third node;
a fourth switching device controlled by the light emission control signal transmitted by the light emission control lines, and connected to the first node and to the light emitting device; and
a storage capacitor having a first terminal connected to the first driving power line and a second terminal connected to the second node.

18. The light emitting display according to claim 14, wherein the second displaying part comprises:
a second pixel circuit defined by the j scan lines and the plurality of data lines for causing the second driving power to have a current corresponding to the data signal in response to the scan signal; and
a plurality of pixels including a light emitting device for emitting light in response to a current outputted by the second pixel circuit.

19. The light emitting display according to claim 18, wherein the second pixel circuit comprises:
a driving transistor having a gate electrode connected to a first node, a source electrode connected to the second driving power line, and a drain electrode connected to the light emitting device;
a switching device controlled by a scan signal transmitted by a scan line, and connected to a data line and the first node; and
a storage capacitor having a first terminal connected to the second driving power line and a second terminal connected to the first node.

20. A light emitting display, comprising:
a first displaying part formed on a substrate and having a plurality of first pixels defined by i first scan lines where i is a positive integer, a plurality of data lines, and a first pixel power line for supplying a first driving power to the plurality of first pixels; and
a second displaying part formed on the substrate and having a plurality of second pixels defined by j second scan lines where j is a positive integer, the plurality of data lines, and a second pixel power line for supplying a second driving power, different from the first driving power, to the plurality of second pixels.

21. The light emitting display according to claim 20, further comprising:
a scan driver for transmitting a scan signal via the i first scan lines, and for transmitting the scan signal via the j second scan lines; and
a data driver for transmitting a data signal via the plurality of data lines.

22. The light emitting display according to claim 21, further comprising a plurality of light emission control lines for transmitting a light emission control signal to the first displaying part.

23. The light emitting display according to claim 22, further comprising a first pixel which comprises:
a first pixel circuit electrically connected to a first scan line, a data line, and a light emission control line for causing the first driving power to have a current corresponding to the data signal in response to a first scan signal transmitted by the first scan line; and
a light emitting device for emitting light in response to a current outputted by the first pixel circuit.

24. The light emitting display according to claim 21, further comprising a second pixel which comprises:
a second pixel circuit electrically connected to a second scan line and a data line for causing the second driving power to have a current corresponding to the data signal in response to a second scan signal transmitted by the second scan line; and
a light emitting device for emitting light in response to a current outputted by the second pixel circuit.

25. The light emitting display according to claim 20, further comprising:
a first power line formed along edges of the substrate except for one edge, the first driving power being supplied to the first power line; and
a second power line formed along an edge of the substrate adjacent to the second displaying part, the second driving power being supplied to the second power line.

26. The light emitting display according to claim 20, wherein the second driving power is greater than the first driving power by at least one volt.
